(19) United States
(12) Patent Application Publication
(10) Pub. No.: US 2013/0226929 A1
(43) Pub. Date: Aug. 29, 2013

(54) SYSTEM AND METHOD FOR GENERATING POSTAL ADDRESSED INDEXED EMAIL DATABASE

(71) Applicants: SANJAY YEERELLY, McKinney, TX (US); MING YU, Plano, TX (US); DWAYNE E. MORTON, Dallas, TX (US)

(72) Inventors: SANJAY YEERELLY, McKinney, TX (US); MING YU, Plano, TX (US); DWAYNE E. MORTON, Dallas, TX (US)

(73) Assignee: MASTERFILES, INC., Dallas, TX (US)

(21) Appl. No.: 13/407,494

(22) Filed: Feb. 28, 2012

(51) Int. Cl. G06F 17/30

(52) U.S. Cl. 707/741; 707/E17.005

(57) ABSTRACT

A system and method for providing a database of physical postal addresses indexed to a general email identifier involves obtaining a plurality of physical postal addresses. The system and method validates whether each of the plurality of physical postal addresses are a valid physical postal address. The system and method next generates a general email address for each of the validated plurality of physical postal addresses and indexes each of the general email addresses to one of the plurality of physical postal addresses.

### TECHNICAL FIELD

The present invention relates to the generation of an e-mail address database, and more particularly to the generation of an e-mail address database that is indexed to the physical postal address of an individual or property associated with the e-mail address.

### BACKGROUND

Using e-mail addresses, individuals are able to quickly transmit various types of electronic information and messages to individuals through their e-mail address. The e-mail message may include text information for transmission to an e-mail recipient and may have various types of electronic files attached thereto to provide further types of information to the e-mail recipient. Present e-mail addresses are associated with individuals but have no particular relationship to the physical address where a person may live or work. Thus, if an individual desires to e-mail information to a particular address area, zip code or physical location, there is no way to tie an e-mail address to a physical mailing address. Thus, there would be a great benefit for having some type of mechanism for associating physical mailing addresses with particular e-mail addresses that may then be utilized for transmitting information to individuals associated with the physical mailing address.

### SUMMARY

The present invention as disclosed and described herein, in one aspect thereof, includes a system and method for providing a database of physical postal addresses indexed to a general email identifier involves obtaining a plurality of physical postal addresses. The system and method validates whether each of the plurality of physical postal addresses are a valid physical postal address. The system and method next generates a general email address for each of the validated plurality of physical postal addresses and indexes each of the general email addresses to one of the plurality of physical postal addresses.

### BRIEF DESCRIPTION OF THE DRAWINGS

For a more complete understanding, reference is now made to the following description taken in conjunction with the accompanying Drawings in which:

FIG. 1 is a block diagram illustrating the manner in which a postal grid of physical postal addresses may be indexed to an e-mail address;

FIG. 2 is a functional block diagram illustrating the manner in which the address to e-mail mapping system converts a list of physical postal addresses to a database of addresses indexed with a system generated e-mail ID and user generated e-mail IDs;

FIG. 3 is a flow diagram illustrating the manner for converting the physical addresses into an index of assigned general e-mail IDs and customer designated e-mail IDs;

FIG. 4 illustrates an address to e-mail indexed table;

FIG. 5 is a flow diagram illustrating the manner in which a user is validated by the system of FIG. 3;

FIG. 6 is a block diagram illustrating the various system tables of the e-mail mapping system of the present disclosure;

FIG. 7 illustrates the inter relationship and elements of the various tables and user profiles within the e-mail mapping system of the present disclosure; and

FIG. 8 is a block diagram illustrating the manner in which the unique electronic identifier generated by the address to e-mail system may be used to carry out electronic commerce and transactions.

### DETAILED DESCRIPTION

Referring now to the drawings, wherein like reference numbers are used herein to designate like elements throughout, the various views and embodiments of a system and method for generating a mailing address indexed e-mail database are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

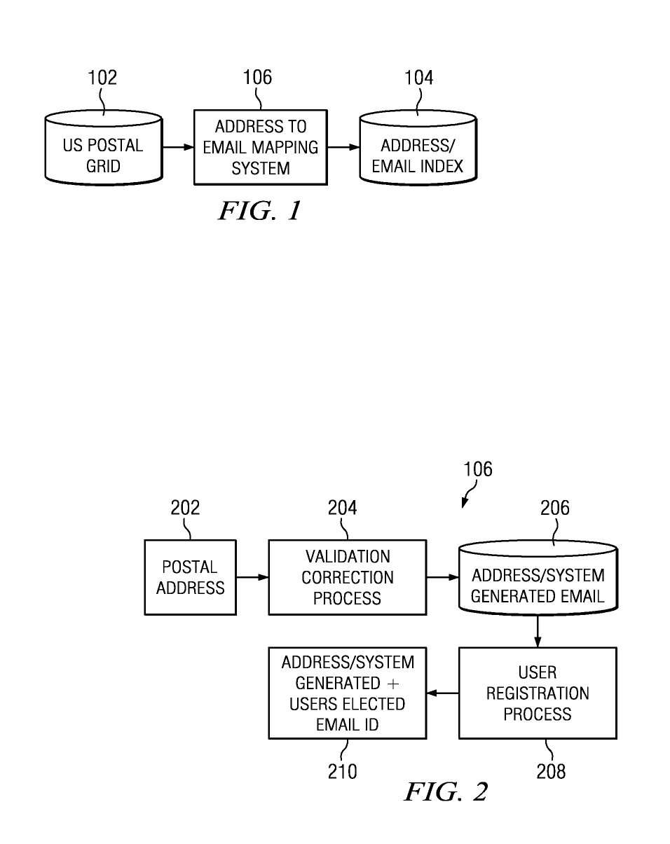

Referring now to the drawings, and more particularly to FIG. 1, there is illustrated a functional block diagram of the system for converting the US postal grid 102 to an address/e-mail index 104 using a postal address to e-mail mapping system 106. The US postal grid 102 consists of all physical mailing addresses within the United States. The postal grid 102 includes every home address, business address, post office box, rural route address, etc. that an individual may address an envelope or package to and mail to within the US postal system. While the present description is made with respect to the indexing of e-mail addresses with the physical addresses of the US postal grid, the present invention will be applicable to the association of e-mail addresses with any postal grid system within any country. The address to e-mail mapping system 106, as will be further described hereinbelow, associates a general e-mail identifier with each of the physical addresses within the US postal grid 102 in order to generate an address/e-mail index 104. The information within the address/e-mail index 104 may be utilized to transmit information and electronic data to individuals that are associated with the physical addresses listed within the US postal grid 102.

Referring now to FIG. 2, there is illustrated a functional block diagram of the address to e-mail mapping system 106 of FIG. 1. Within the address to e-mail mapping system 102 each of the physical postal addresses 202 are received from the US postal grid 102. Each of the postal addresses 202 go through a validation and correction process 204 wherein each of the postal addresses 202 are confirmed as accurate and valid US postal addresses, and when incorrect addresses are found, these are corrected. Next, each of the validated and/or corrected physical postal addresses are associated with a system generated e-mail ID. The system generated e-mail ID is unique for each physical address that is received. Thus, an individual using the system generated e-mail ID or user selected ID associated with system generated ID may transmit an e-mail to an individual that is associated with the physical postal address.

The system generated e-mail ID format of general e-mails may be of the form of [e-mail ID].epm, where the .epm is the top level domain name that is uniquely associated with all e-mail addresses that have been generated according to the present disclosure to be associated with a physical postal address. While the present discussion utilizes the .epm designation as the top level domain name, it will of course be realized that any top level domain name designation that is uniquely associated with e-mail addresses that are associated with the physical postal address as described herein would be applicable.

This address/system generated e-mail ID index 206 may be accessed by individuals through a user registration process 208. The user registration process 208 enables a user to register with the address to e-mail mapping system 106 and validate that they are living at or associated with a particular physical postal address 202. Once the user is validated by the user registration process 208, the user may associate an additional user designated e-mail ID with the address/system generated e-mail ID at 210. This allows the user to receive e-mails associated with the postal address 202 at either of the system generated e-mail ID or user designated e-mail ID that is associated with the system generated e-mail ID. The user may also establish a number of sub accounts including additional user designated e-mail IDs that are also associated with the same physical postal address 202. This enables multiple e-mails to the provided to differing individuals at a same physical address.

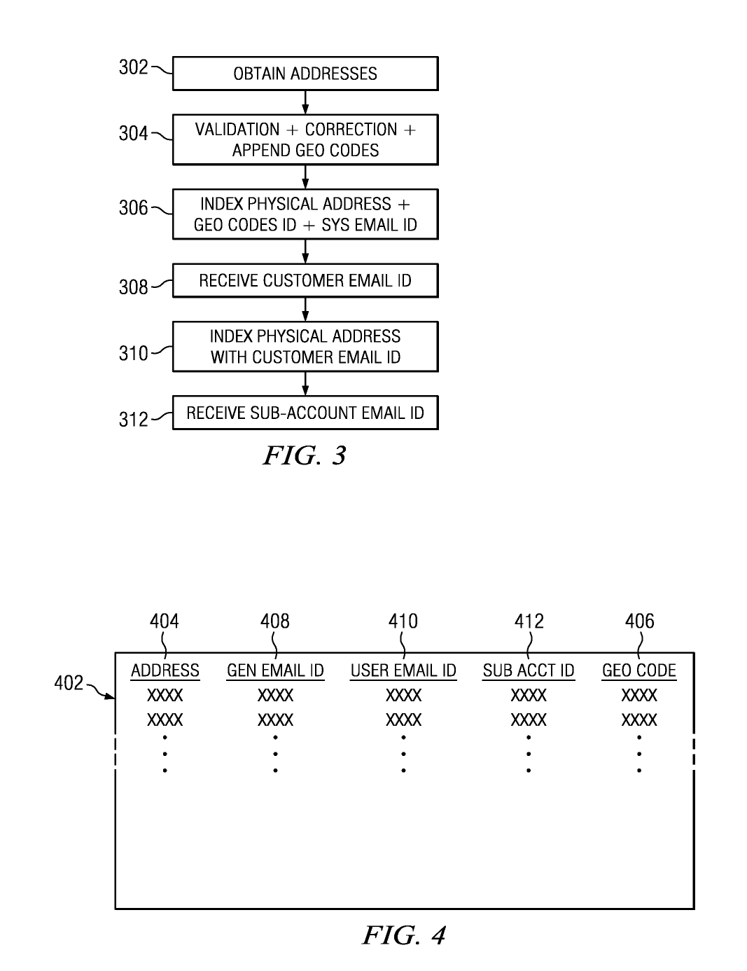

Referring now to FIG. 3, there is illustrated a flow diagram describing the process for generating an index of physical postal address with system generated e-mail IDs and customer designated e-mail IDs according to the present disclosure. The physical postal addresses are obtained from various available databases at step 302. For each of the received physical postal addresses obtained at 302, a validation process is performed at step 304 to confirm that the postal address comprises an actual physical postal address. This validation can be performed by, for example, a third party CASS program. Other types of validation programs or processes may also be used to perform the validation. When invalid addresses are found, these addresses are corrected at step 304, as necessary, to provide an accurate physical postal address. After the address has been validated, a geo code indicating the geographical location of the postal address is associated with the physical postal address at step 304. At step 306, the validated physical postal addresses are indexed with the geo code IDs and a system e-mail ID.

Once a general index has been created having the physical postal address associated with the geo code ID and system e-mail ID, customers that have registered with the system may designate their own e-mail IDs that are indexed with the physical postal address. Once the customer e-mail ID is received at step 308, this newly received customer e-mail ID is indexed with the associated physical postal address at step 310. Finally, additional customer e-mail IDs and subaccount e-mail IDs may also be provided, and once received at step 312, are indexed with the physical postal address such that multiple customer e-mail addresses are associated with a single physical postal address location.

Once this process is completed, the indexed table, as illustrated in FIG. 4, may then be provided for use in providing e-mail contacts with the postal addresses. The table 402 illustrated in FIG. 4 includes a plurality of entries that are each associated with a unique physical postal address 404. The table 402 has associated with the postal address entries 404 and a number of identifier that are each indexed with a particular postal address. These identifiers include the geo code ID 406 that is an identifier indicating a geographic location associated with the address 404. The general e-mail identifier 408 is the system generated e-mail address that is associated with the particular physical postal address 404.

Registered users with the system may establish additional e-mail identifiers with the physical postal address 404 including the user e-mail identifier 410 and the sub account e-mail identifier 412. The user e-mail ID 410 is a user e-mail address that has previously been assigned or attributed to the user that may be also associated with the general e-mail ID 408 and the associated physical postal address 404. Additional sub account e-mail IDs 412 may also be associated with the general e-mail ID 408 and physical postal address 402. The sub account e-mail ID 412 comprises additional user e-mail addresses that are associated with the physical postal address 404 for additional users at the address. This would be a case wherein, for example, multiple members of a family were living at a same physical postal address 404. Each sub account ID is associated with a husband, wife, or each of the children within the home. Each individual may also have multiple e-mail addresses associated with them within the sub account e-mail ID 412.

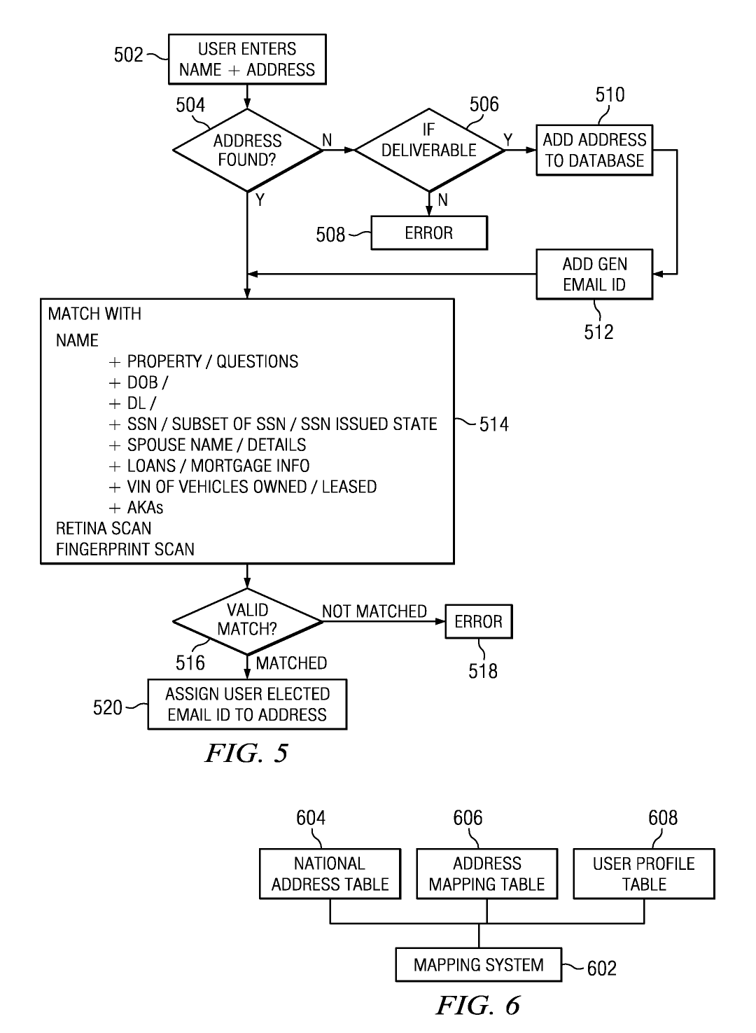

Referring now to FIG. 5, there is more particularly illustrated the manner in which a user is validated with respect to a provided address in order to enable the user to establish their own user e-mail ID and sub accounts with respect to a particular physical postal address and the system generated e-mail associated therewith. The user enters a name and address at step 502. The address comprises a physical postal address location and the name of the user that is living or working there. Step 504 determines if the entered address is located within the provided master index of postal e-mail addresses and system generated e-mail IDs. If the address is not located within the existing database, inquiry step 506 determines if the entered address is a deliverable US postal address. If inquiry step 506 determines that the user has not entered a deliverable postal address, an error message is provided at step 508. If inquiry step 506 determines that the entered address is a deliverable US postal address, the entered address is added to the database at step 510 and a system generated e-mail ID is indexed with the additional address at step 512.

After previously unentered postal addresses have been added to the database at step 510 and 512 or if inquiry step 504 determines that the user entered address is presently located within the database, the association of the user name with the provided postal address is validated at step 514. The validation process at step 514 performs a procedure for confirming that the name that has been provided by the user at step 502 is in fact associated with the address that has been entered. The validation process may be performed in a number of ways such as the user answering one or more questions with respect to the property associated with the address that the user has entered. Additionally, the user may be required to enter information such as their date of birth, a driver's license number, a social security number or some other type of governmental or state issued ID, the name of their spouse and details about their spouse, information with respect to loans and/or mortgages associates with the property at the address, information with respect to a vehicle identification number of vehicles that are owned or leased by individuals associated with the property.

Alternatively, the identity of the user can be established using some type of biometric data such as a retinal scan or fingerprint scan. The purpose of the process carried out at step 514 is to confirm in some manner that the user name that has been entered with respect to the address at step 502 is in fact validly associated with the address and entitled to received e-mail associated with the address. After the user match process is performed at step 514, inquiry step 516 determines if a valid match has occurred. If not, an error message is provided at step 518. If a valid match was achieved, the user is able to assign a user elected e-mail identifier with the physical postal address at step 520. This enables the user to receive an e-mail at an e-mail ID of their choosing rather than the general e-mail ID that has been assigned by the system.

Referring now to FIG. 6, there are illustrated the various tables and their interrelationship associated with the address to e-mail mapping system 602 and the database of physical postal addresses indexed with general e-mail IDs and user designated IDs. The mapping system 602 may be implemented in a number of fashions including within a computer processing unit, programmable logic unit, online server, software program or any other type of computer based instructions or computer based instructional units that enable the various functions and processes that are described herein to be carried out with respect to the generated databases and informational databases that are accessed by the e-mail mapping system 602. The mapping system 602 interacts with a national address table 604, an address mapping table 606 and a user profile table 608. The national address table 604 includes various types of information associated with each physical postal address that is entered into the system. The particular information will be more fully discussed hereinbelow. The address mapping table 606 includes information with respect to the particular addresses and e-mail IDs that are indexed/associated therewith. The user profile table 608 contains information with respect to the individuals that are registered with the system and have been validated via the process described previously with respect to FIG. 5.

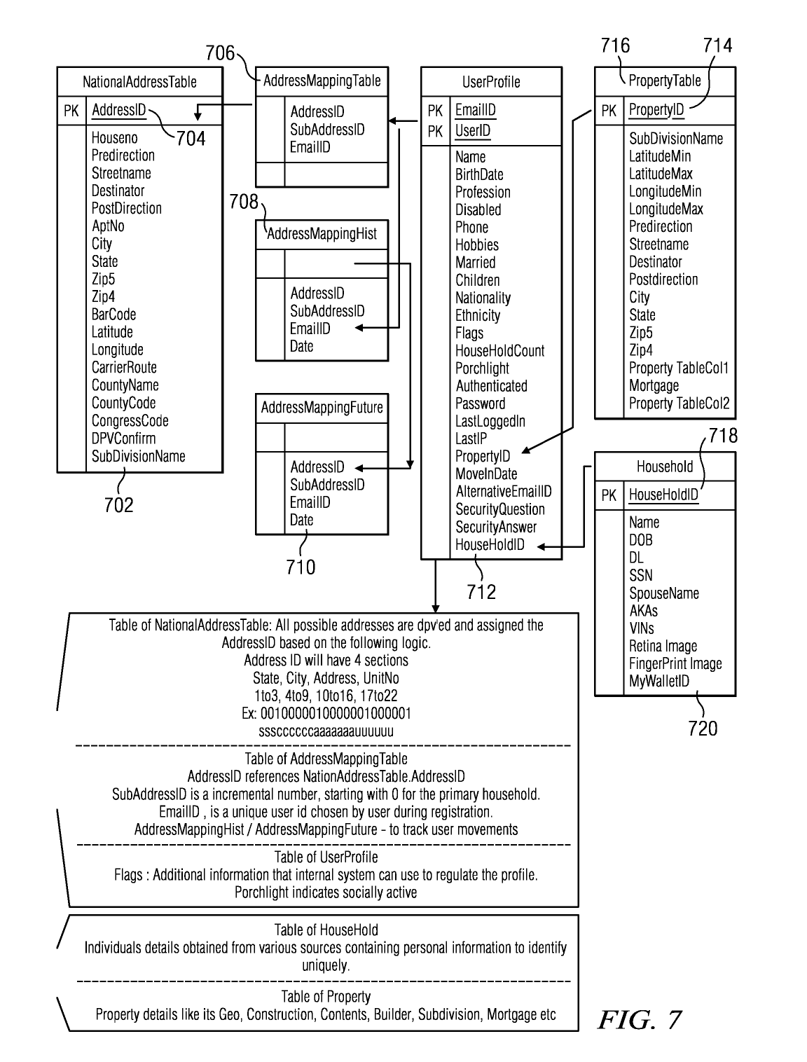

Referring now to FIG. 7, there is provided more detail relating to the various tables contained within the address to e-mail mapping system and their interrelationship with each other and other related sub-tables. The national address table 702 includes the address information associated with each of the physical postal addresses that are stored by the system. Within the national address table 702 all possible addresses are derived and designed based upon the following elements. Each address ID will have four sections including state, city, address, unit number. The state is indicated using characters 1-3 of the address ID. The city field is indicated using characters 4-9 of the address ID. The address field is indicated using characters 10-16 of the address ID, and the unit number is indicated using characters 17-22 of the address ID. The address ID 704 is the particular physical address designator for a specific location such as 1234 Brown Street. Each address ID 704 has associated therewith a number of identifiers relating to the address. These include information such as the house number providing the numerical designator for an address, a predirection indicating pre directional of an address, the street name at which the address is located, a designator indicating a suffix of the address, a post direction indicating a post directional of an address, an apartment number indicating a particular apartment unit at a multi-unit address having a number of different living units or business units at a same top level address, a city indication, a state indication and zip code indication including both the five digit zip code and the four digit extended zip code. In addition to this type of standard address information a bar code may be included for providing a bar code identifier associated with each particular address.

Additional information such as longitude and latitude of the address may provide a particular geo location designation for the address. A postal carrier route designator may also be provided such as Route 4, Box 15W. Country names and country codes may also be included within the address designation information for use when the database is used within multiple countries. The congress code indicates the Congressional District Code of that address. The DPV confirm code indicates the Mail Deliverable Flag of that address. A subdivision name may also be included in areas wherein a home is located within a particular sub division having a particular name for further identification of the address.

Each address ID 704 has an entry within the national address table 702 that has some or all of this information associated therewith. The address mapping table 706 includes additional information with respect to the address ID. The address mapping table 706 uses the address ID 704 that references the address ID within the national address table 702. The sub address ID is an incremental number starting with 0 for the primary household member and incrementing by 1 for each additional member of the household. The e-mail ID is a unique user ID that is chosen by the user when they register with the system. Within the address mapping table 706 are an e-mail ID for the assigned general e-mail ID and sub address ID for user designated e-mail IDs. The e-mail ID is the system generated ID that is associated with a particular physical postal address by the mapping system. The sub address ID may also be associated with the e-mail and include information such as user designated e-mail addresses associated with the address and additional user e-mail sub account addresses that are also associated with the address ID.

An address mapping history sub table 703 provides information indicating when the address ID, sub address ID and/or e-mail ID were created providing date specific information with respect thereto. The address mapping future table 710 provides information with respect to the address ID, sub address ID and e-mail ID regarding a new property that the household intends to move to which is equal to the Address relocate service by USPS. The address mapping history table 708 and address mapping future table 710 enable the tracking of user movements.

A user profile 712 associates a user ID with the general e-mail ID that has been generated by the system for registered and validated users. The user profile 712 information will have a listing of user information associated with each user ID such as name, birth date, profession of user, whether or not the user is disabled, phone number, hobbies, marital status, number of children, nationality and ethnicity. The user ID may also include particular information about the property at which the user lives such as flag, household count, porch light, a property ID and move-in date of the property. The user profile table flags designation provides additional information that the system can use to regulate the profile of the individual. The porch light identifier indicates whether the user is socially active. Various types of security information with respect to the user ID may also be included in the user profile 712 such as an indication of whether the user is authenticated, a password, last log-in time, last use IP address, security questions and security answers. Additional contact or alternative e-mail ID information may also be included within the user profile 712 to enable additional e-mail addresses to be associated with a particular address ID.

The property ID 714 within the user profile 712 may additionally have a property table 716 associated therewith. The property table 716 includes a variety of different information about a particular property associated with an address ID. The property ID 714 can include information such as a subdivision name, latitude min value, latitude max value, longitude min value and longitude max value, a predirection value, street name, destinator, post direction, city, state and zip code including both the five digit zip code and four digit zip code.

Additionally, a household ID 718 within the user profile 712 may include various household identification information. The household table 720 includes the various household IDs 718. Each household ID 718 within the household table 720 includes information such as name of the individual in the household, their date of birth, their driver's license, their social security number, their spouse's name, also known as alternative identities, vehicle identification numbers of vehicles driven by the individual. Biometric information such as a retina image or fingerprint image of the individual may also be stored. The household table 720 provides details about individuals obtained from various sources containing personal information enabling the individuals to be uniquely identified. The household table 720 also includes the MyWalletID to enable an individual associated with the postal address to carry out electronic commerce transactions using the generated unique electronic identifier. The property table 716 provides information concerning the property such as each geographic location, type of construction, contents of the property, builder of the property, sub division in which the property is located and any mortgages associated with the property.

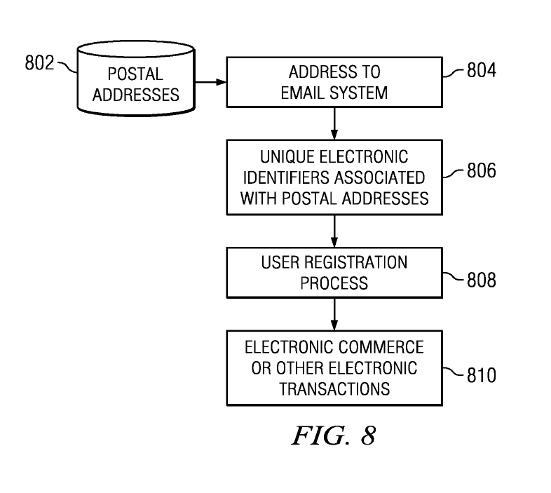

Referring now to FIG. 8, there is illustrated a block diagram describing the manner in which the address to e-mail system 804 may be used to provide secure electronic communications and transactions to unique identifiers associated with addresses in the postal group. Postal addresses 803 are provided to the address to e-mail system 804 in the manner described previously. As discussed hereinabove, the address to e-mail system 804 generates unique electronic identifiers that are associated with each of the postal addresses at 806 and enables individuals to register with the system and receive communications and carry out transactions using this unique e-mail identifier. The user registration process 808 enables a user to register with and receive information through the unique electronic identifier associated with a particular address. This allows household entities, users, associated with the postal address to carry out electronic commerce transactions using the unique electronic identifier. Using this unique electronic identifier, electronic commerce and other type of electronic transactions may be carried out at step 810. Thus, the address to e-mail system enables the addresses 802 associated with the postal delivery system to be implemented in the electronic realm. The address to e-mail system transforms any standard postal address into a unique identifier source e-communications address 806. The address to e-mail system 804 provides for secure electronic transactions enabling customers to use the system of address registration as an e-communications point to transact all levels of electronic commerce and transactions within a secure environment where they note the customer resides at a particular address associated with the unique electronic identification identifier.

Thus, using the above-described system and method, a database having physical postal addresses indexed to a system generate e-mail identifier may be created. E-mails may then be transmitted to this e-mail address that is uniquely associated with the address. A user may register within the system to provide an additional user designated e-mail that may be uniquely associated with the physical postal address rather than using the system generated general e-mail address. Additionally, sub accounts may enable multiple individuals to be associated with the same physical postal address for situations where multiple individuals are living at a same location. This will allow information associated with the address to be e-mailed to individuals that are located at that address providing valuable delivery and potential marketing opportunities utilizing the created database.

It will be appreciated by those skilled in the art having the benefit of this disclosure that this system and method for generating a database of physical postal addresses indexed to an associated e-mail address provides a convenient method for directing electronic mail to particular geographical areas. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1. A database, comprising:
a plurality of physical postal addresses; and
a plurality of email identifiers, each of the email identifiers indexed with one of the plurality of physical postal addresses, each of the plurality of email identifiers having a same top level domain name indicator associated therewith.

2. The database of claim 1, further including a plurality of user designated email identifiers, each indexed with one of the plurality of physical postal addresses indexed with the email identifier, the user designated email identifier established by a validly registered user.

3. The database of claim 1, further including a geo code associated with of the plurality of physical postal addresses, the geo code indicating a geographic location of the physical postal addresses.

4. The database of claim 1, further including at least one sub-account associated with at least one of the plurality of physical postal addresses, the sub-account associated with a second user at the physical postal address.

5. The database of claim 1, wherein each of the plurality of physical postal addresses has been established as a valid postal address.

6. A method for generating a database of physical postal addresses indexed to a general email identifier, comprising:
obtaining a plurality of physical postal addresses;
validating whether each of the plurality of physical postal addresses are a valid physical postal address;
generating a general email address for each of the validated plurality of physical postal addresses; and
indexing each of the general email addresses to one of the plurality of physical postal addresses.

7. The method of claim 6, wherein the step of validating further comprises:
confirming that a physical postal address is a valid address;
rejecting the physical postal address from the database if the physical postal address is not a valid address; and
adding the physical postal address to the database if the physical postal address is a valid address.

8. The method of claim 6, further comprising the steps of:
receiving a request from a user to register with respect to a selected physical postal address;
confirming the user is associated with the selected physical postal address; and
indexing a user provided email address with the general email address and the selected physical postal address responsive to confirmation that the user is associated with the physical postal address.

9. The method of claim 8, wherein the step of confirming the user is associated with the selected physical postal address further comprises the steps of:
providing a series of questions to the user for confirming the association of the user with the selected physical postal address;
receiving user responses to the series of questions; and
confirming the user is associated with the selected physical postal address responsive to answers to the series of questions.

10. The method of claim 8, wherein the step of confirming the user is associated with the selected physical postal address further comprises the steps of:
receiving biometric data from the user;
confirming the user is associated with the selected physical postal address responsive to the biometric data.

11. The method of claim 6, further including the step of indexing a user provided email address with a selected physical postal address and the general email address.

12. The method of claim 11, further including the step of adding at least one sub-account to a selected physical postal address, wherein the at least one sub-account has a second user provide email address associated therewith.

13. A system for indexing a plurality of physical postal addresses with a general email identifier, comprising:
an address/email mapping table for storing a plurality of physical postal addresses each having a general email address associated therewith, each of the general email addresses having a same top level domain name associated therewith;
a user profile table including information on users that have registered with the system and been validated as being associated with one of the plurality of physical postal addresses;
a computer processing unit associated with the address/email mapping table and the user profile table;
wherein the computer processing unit is programmed to receive the plurality of physical postal addresses and confirm a validity of each of the plurality of physical postal addresses;
wherein the computer processing unit is further programmed to generate the general email address and index the general email address with a validated physical postal address; and
wherein the computer processing unit is further programmed to validate a user with respect to a selected physical postal address.

14. The system of claim 13, wherein the address/email mapping table further includes a plurality of user designated email identifiers, each indexed with one of the plurality of physical postal addresses indexed with the email identifier, the user designated email identifier established by a validly registered user within the user profile table.

15. The system of claim 14, wherein the computer processing unit is further configured to store and index a user designated email identifier within the address/email mapping table responsive to receipt of the user designated email identifier from a validly registered user within the user profile table.

16. The system of claim 13, wherein the address/email mapping table further includes at least one sub-account associated with a second user that has been validated as being associated with the physical postal address.

17. The system of claim 16, wherein the computer processing unit is further configured to validate a second user with respect to a selected physical address and create a sub-account for the second user that is indexed with the selected physical address and the general email address.

18. The system of claim 13, wherein the address/email mapping table further includes a geo-code indexed with each of the plurality of physical postal address indicating a physical location of the physical postal address.

19. The system of claim 13, wherein the computer processing unit is further configured to receive receiving a request from a user to register with respect to a selected physical postal address, to confirm the user is associated with the selected physical postal address and to index a user provided email address with the general email address and the selected physical postal address responsive to confirmation that the user is associated with the physical postal address.

20. The system of claim 13, wherein the computer processing unit is further configured to provide a series of questions to the user for confirming the association of the user with the selected physical postal address, to receive user responses to the series of questions and to confirm the user is associated with the selected physical postal address responsive to answers to the series of questions.

21. The system of claim 13, wherein the computer processing unit is further configured to receive biometric data from the user and to confirm the user is associated with the selected physical postal address responsive to the biometric data.
